(19) United States
(12) Patent Application Publication
(10) Pub. No.: US 2013/0162540 A1
(43) Pub. Date: Jun. 27, 2013

(54) INPUT DEVICE WITH DIFFERENT INPUT FUNCTIONS

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: QIANG YOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/720,580

(22) Filed: Dec. 19, 2012

(30) Foreign Application Priority Data
Dec. 26, 2011 (CN) 201110440916.5

(51) Int. Cl. G06F 3/041

(52) U.S. Cl. CPC G06F 3/041
USPC 345/168

(57) ABSTRACT

A multifunctional input device includes a keyboard body defining a recess, a flexible touch panel movably received in the recess of the keyboard body, and a switching sensor. The switching sensor generates a first mode signal or a second mode signal. Only the keyboard body works when the switching sensor generates the first mode signal, and only the flexible touch panel works when the switching sensor generates the second mode signal.

### BACKGROUND

1. Technical Field

Embodiments of the present disclosure relate to an input device which can provide both keyboard input function and touch input function.

2. Description of Related Art

Input devices may be of different kinds, such as keyboards and touch panels. However, the keyboards and the touch panels are different input devices and a typical input device cannot provide both keyboard input function and touch input function.

Thus, a need exists to overcome the above-described shortcomings

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic diagram of an implementation of an input device according to one embodiment of the present disclosure, the input device connecting to a computer.

FIG. 2 is a schematic, block diagram of the input device and the computer of FIG. 1, according to one embodiment of the present disclosure.

FIG. 3 is a schematic, isometric view of the input device of FIG. 1, according to one embodiment of the present disclosure, the input device including a keyboard body and a flexible touch panel.

FIG. 4 is a schematic, side view of the input device of FIG. 1, the flexible touch panel being rolled up and received in the keyboard body.

FIG. 5 is a schematic, side view of the input device of FIG. 1, the flexible touch panel being opened up and covering the keyboard body.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

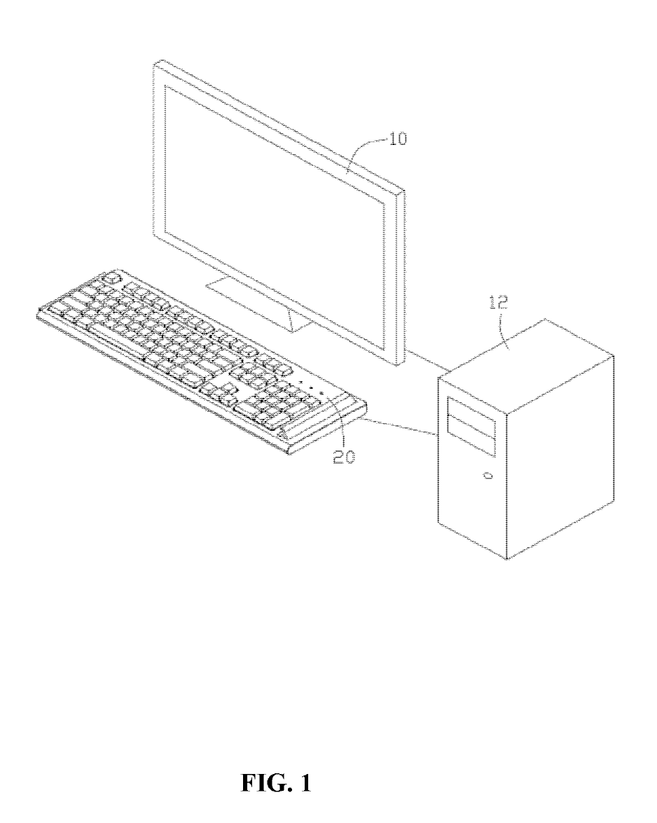

Referring to FIG. 1, a schematic diagram of an implementation of an input device 20 according to one embodiment is shown. In this embodiment, the input device 20 is connected to a computer 12 and functions as an input device. A display 10 is also connected to the computer 12 and alters the display according to input from the input device 20. In this embodiment, the input device 20 may be connected to the computer 12 via cable or wirelessly.

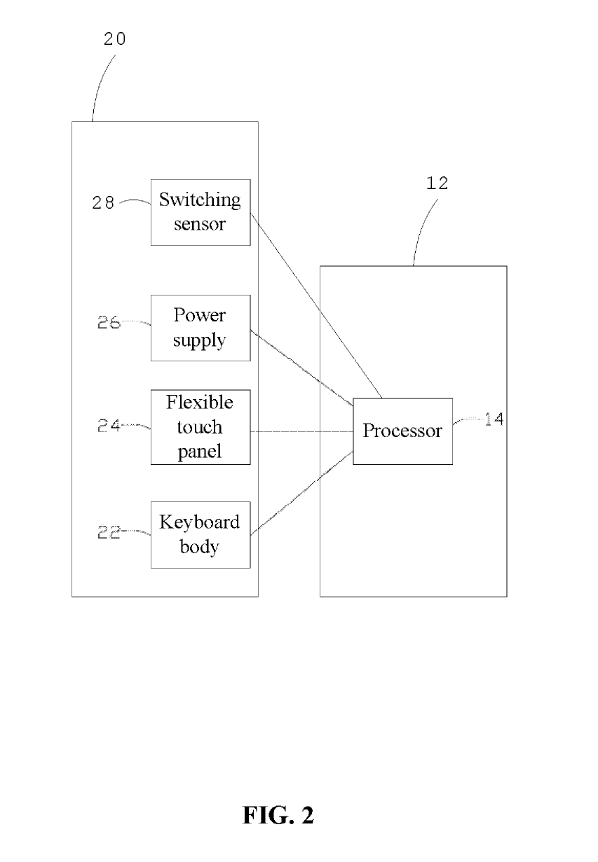

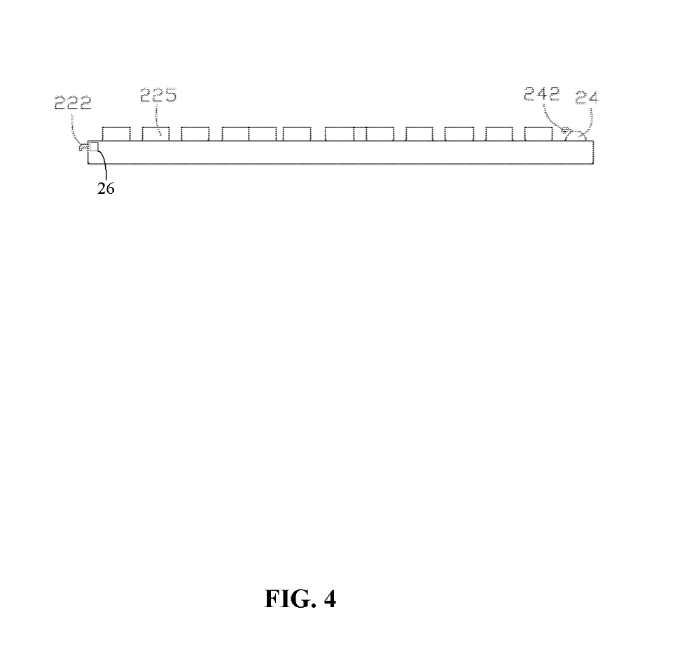

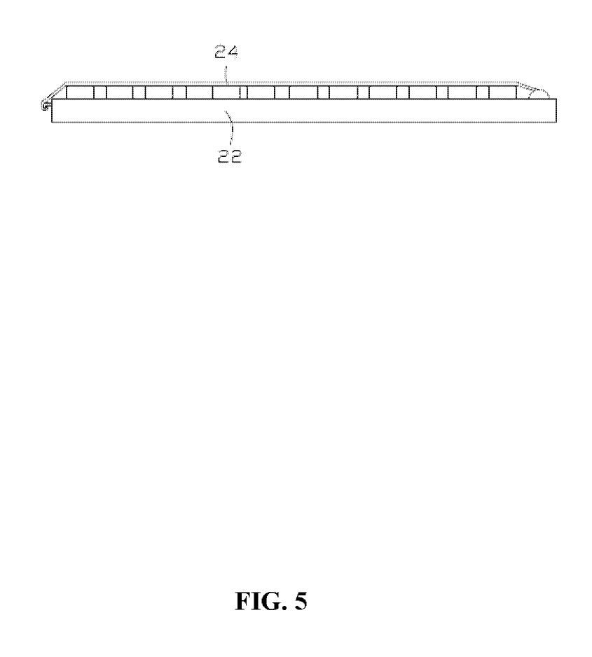

Referring to FIG. 2, the input device 20 includes a keyboard body 22, a flexible touch panel 24, a switching sensor 28, and a power supply 26 for providing voltages to the flexible touch panel 24 and to the switching sensor 28. The computer 12 includes a processor 14. When the flexible touch panel 24 is rolled up and received in the keyboard body 22 as shown in FIG. 4, the input device 20 works only in a keyboard input mode, and the input device 20 performs as a typical computer keyboard using the keyboard body 22. When the input device 20 works in a touch input mode, the flexible touch panel 24 may be drawn out to cover the keyboard body 22 as shown in FIG. 5 such that only the flexible touch panel 24 works and the input device 20 performs only as a touch input device. The first input mode and the second input mode are switched according to a signal generated by the switching sensor 28.

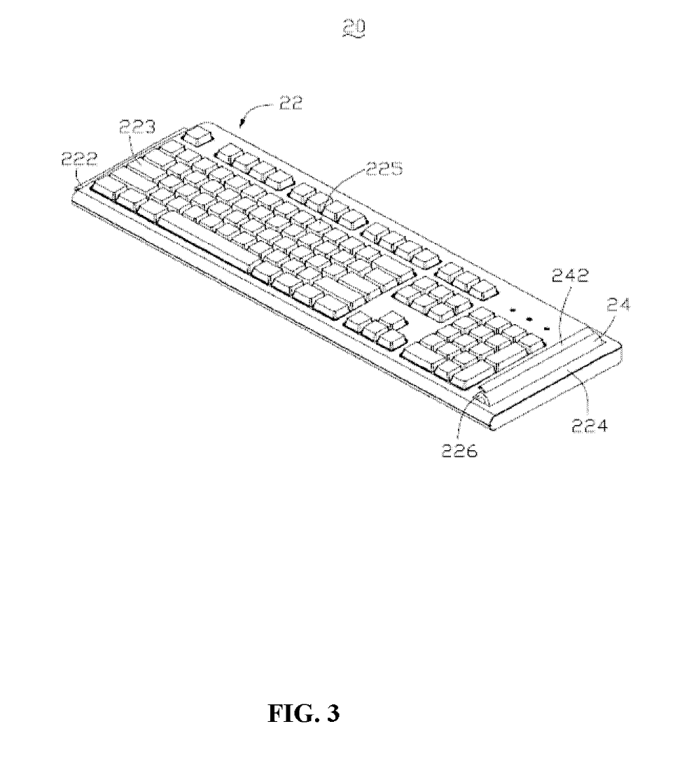

Referring to FIG. 3, the keyboard body 22 includes a keypad area 223 and two periphery areas 224 positioned at opposite sides of the keypad area 223. The keypad area 223 includes a plurality of input buttons 225. One of the two periphery areas 224 defines a recess 226 for receiving the rolled-up flexible touch panel 24. The flexible touch panel 24 includes a first fixing unit 242, such as a hook, at its free end. The input device 20 further includes a second fixing unit 222, such as a protrusion, at the other one of the two periphery areas 224. In this embodiment, the protrusion extends from the side of the keyboard body 22 farthest away from the recess 226, as shown in FIG. 4. The switching sensor 28 is mounted in the keyboard body 22 adjacent to the second fixing unit 222. The first fixing unit 242 and the second fixing unit 222 fix and maintain the flexible touch panel 24 in place when the flexible touch panel 24 is opened up. The switching sensor 28 detects when the first fixing unit 242 is engaged with the second fixing unit 222. The switching sensor 28 generates a first mode signal when the first fixing unit 242 is not engaged with the second fixing unit 222, and generates a second mode signal when the first fixing unit 242 is engaged with the second fixing unit 222. The processor 14 determines that the input device 20 works in the keyboard input mode when receiving the first mode signal, and determines that the input device 20 works in the touch input mode when receiving the second mode signal. The power supply 26 can also receive, and act upon, the first mode signal and the second mode signal. The power supply 26 provides voltages only to the keyboard body 22 when receiving the first mode signal and provides voltages only to the flexible touch panel 24 when receiving the second mode signal. In an alternative embodiment, the switching sensor 28 may be integrated with the first fixing unit 242, or with both, or one of, the first fixing unit 242 and the second fixing unit 222.

In other embodiments, the power supply 26 is controlled by the processor 14 according to receiving the first and the second mode signals. That is, the processor 14 controls the power supply 26 to provide voltages to only the keyboard body 22 when the processor 14 receives the first mode signal, and only to the flexible touch panel 24 when the processor 14 receives the second mode signal.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. An input device comprising:
a keyboard body defining a recess,
a flexible touch panel movably receiving in the recess of the keyboard body, and
a switching sensor configured for generating a first mode signal and a second mode signal, wherein only the keyboard body works when the input device operates in a keyboard input mode according to the first mode signal, and only the flexible touch panel works when the input device operates in a touch input mode according to the second mode signal.

2. The input device of claim 1, wherein the flexible touch panel is rolled up and received in the recess of the keyboard body, when the input device works in the keyboard input mode.

3. The input device of claim 1, wherein when the flexible touch panel is drawn out to cover the keyboard body, the input device works in the touch input mode.

4. The input device of claim 1, wherein the keyboard body comprises a keypad area and two periphery areas positioned at opposite sides of the keypad area, the keypad area comprises a plurality of input buttons.

5. The input device of claim 4, wherein the recess is defined in one of the two periphery areas.

6. The input device of claim 5, further comprising a first fixing unit formed at a free end of the flexible touch panel and a second fixing unit formed at the other one of the two periphery areas, wherein the first fixing unit and the second fixing unit are configured for fixing the flexible touch panel when the flexible touch panel is drawn out to cover the keyboard body.

7. The input device of claim 6, wherein the first fixing unit is a hook and the second fixing unit is a protrusion extended from a side of the keyboard body away from the recess.

8. The input device of claim 7, wherein the switching sensor is mounted in the keyboard body adjacent to the second fixing unit.

9. The input device of claim 8, wherein the switching sensor generates the first mode signal when the switching sensor detects that the first fixing unit is not engaged with the second fixing unit, and the switching sensor generates the second mode signal when the switching sensor detects that the first fixing unit is engaged with the second fixing unit.

10. The input device of claim 9, wherein the input device is connected to a computer via cable or wirelessly.

11. The input device of claim 10, wherein the computer determines that the input device works in the keyboard input mode when the computer receives the first mode signal, and the computer determines that the input device works in the touch input mode when the computer receives the second mode signal.

12. The input device of claim 9, further comprising a power supply configured for providing operation voltages to the flexible touch panel and the switching sensor.

13. The input device of claim 12, wherein the power supply provides operating voltages to only the keyboard body when the power supply receives the first mode signal, and provides operating voltages to only the flexible touch panel when the power supply receives the second mode signal.
